(19) United States
(12) Patent Application Publication
(10) Pub. No.: US 2005/0224697 A1
(43) Pub. Date: Oct. 13, 2005

(54) Light-receiving circuit capable of expanding a dynamic range of an optical input

(76) Inventor: Naoki Nishiyama, Yokohama-shi (JP)

Correspondence Address: MCDERMOTT WILL & EMERY LLP, 600 13TH STREET, N.W., WASHINGTON, DC, 20005-3096, US

(21) Appl. No.: 10/820,146

(22) Filed: Apr. 8, 2004

(51) Int. Cl. H01J 40/14

(52) U.S. Cl. 250/214 A; 250/214 R

(57) ABSTRACT

The present light-receiving circuit includes a light-receiving device, typically an avalanche photodiode (APD), a bias supply, a reference resistor and a feedback control circuit. The APD receives an optical signal with a predetermined transmission speed. The bias supply provides a bias voltage to the APD. The reference resistor detects a signal current generated by the APD. The feedback control circuit receives the signal current detected by the reference resistor and controls the bias supply such that the signal current detected by the reference resistor is maintained to be a predetermined magnitude.

### BACKGROUND OF THE INVENTION

1. Field of the Invention

The present invention relates to an light-receiving circuit for an optical communication, especially for the light-receiving circuit using an avalanche photodiode as a light-receiving device.

2. Related Prior Art

The avalanche photodiode (APD) is often used as a light-receiving device for a faint optical signal because the APD enables to gain carriers from a single photon entered therein. An index called as the M-value is well known, which denotes the multiplication factor how many carriers does the APD generates from a single photon. The M-value strongly depends on, nearly nonlinear to the bias condition V_{APD} applied to the APD.

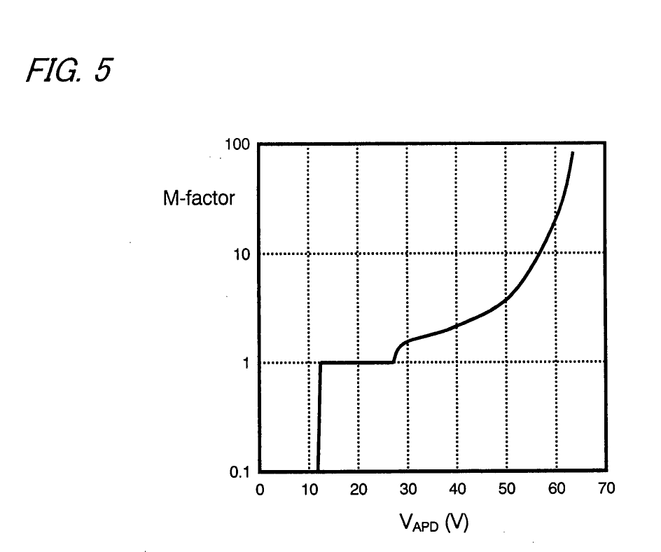

FIG. 5 shows an example of the behavior of the M-value to the bias V_{APD}. When the V_{APD} is smaller than 11V, the APD generates nearly no carrier, namely, even if the signal light enters the APD, no corresponding electrical signal can be obtained. Exceeding the bias V_{APD} over 11V, the APD generates one carrier for one photon entering the APD, namely, the M-value is nearly equal to 1. This region, where the M-value is unity, is called as the photodiode region.

Further increasing the bias V_{APD} and exceeding 27V, the M-value becomes larger than unity, where the APD generates a plurality of carriers for one photon, namely, the region is called as the APD region. In this APD region, the M-value shows strong dependence on the bias condition V_{APD}.

When the APD is operates in a fixed bias condition, for example, the bias is fixed to 40V in FIG. 5, the obtained signal from the APD is large because the M-value in this region is about 2.5, which enables to design the electronic circuit which is subsequently connected to the APD and receives the large output from the APD. However, for an optical signal with relatively great magnitude, the subsequent electronic circuit may saturate because the M-value of the APD is maintained to be about 2.5 and the APD outputs an greater electronic signal.

In a conventional light-receiving circuit for the APD, a resistor is serially connected to the APD to expand a dynamic range of the APD. The resistor controls the bias V_{APD} applied to the APD by a current feedback thereof. When the input light has a great magnitude and the APD generates a large current, the bias thereto is lowered by a voltage drop at the serially connected resistor, thus current feedback operation is realized.

However, such current feedback operation by the serially connected resistor is only for the condition that the APD receives the large optical input. For is small and faint optical input, the serially connected resistor shows no function to the APD.

### SUMMARY OF THE INVENTION

Therefore, one object of the present invention is to provide a light-receiving circuit for the APD, which enables to enhance the dynamic range thereof.

According to one aspect of the present invention, an light-receiving circuit includes a light-receiving device, a bias supply, a reference resistor and a feedback control circuit. The light-receiving device is preferably an avalanche photodiode and receives an optical signal with a predetermined transmission speed. The bias supply provides a bias voltage to the light-receiving device. The reference resistor detects a signal current generated by the light-receiving device. The feedback control circuit receives the signal current detected by the reference resistor and controls the bias supply such that the signal current detected by the reference resistor is maintained to be a predetermined magnitude.

The bias supply may include a high voltage source and a voltage control circuit serially connected to the high voltage source. The feedback control circuit may adjust the bias voltage provided to the light-receiving device via the voltage control circuit.

The light-receiving circuit may further comprise a current mirror circuit, which has one input port connected to the output of the bias supply and two output ports. One of two output ports is connected to the light-receiving device, while the other of two output ports is connected to the reference resistor, whereby the current flowing the reference resistor is equivalent to the current generated by the light-receiving device.

The feedback control circuit may has a time constant greater than the predetermined speed to stabilize the feedback operation thereof The light-receiving device may be a PIN photodiode instead of the avalanche photodiode, a cathode of which is connected to the bias supply.

### BRIEF DESCRIPTION OF THE INVENTION

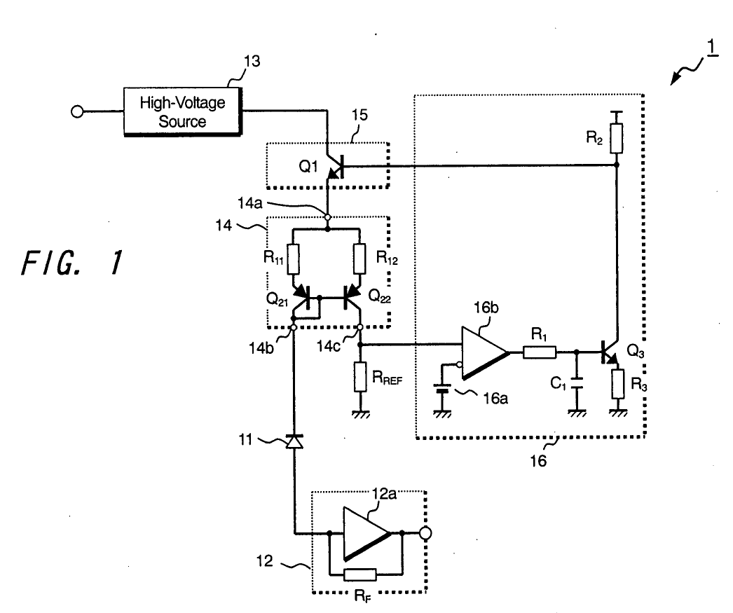

FIG. 1 is the light-receiving circuit according to the first embodiment of the present invention;

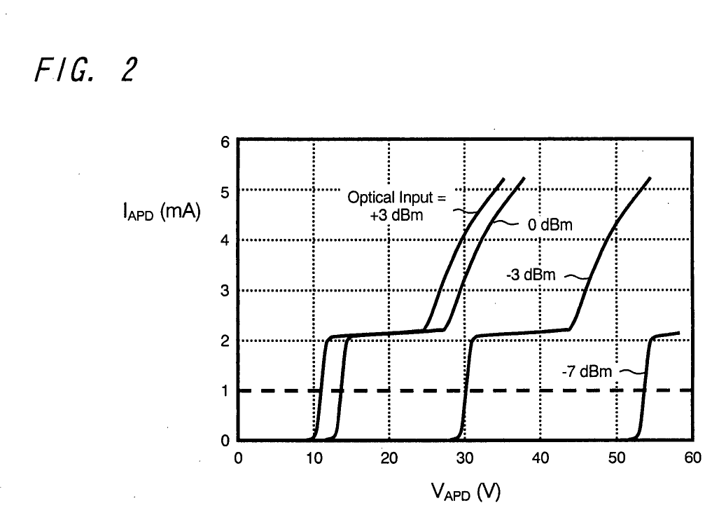

FIG. 2 shows an optical response of the avalanche photodiode to the applied bias voltage;

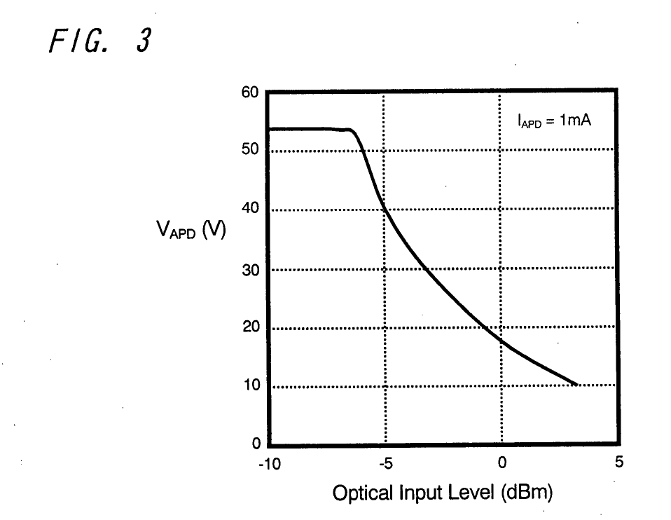

FIG. 3 shown a bias condition of the avalanche photodiode in which the avalanche photodiode gives a predetermined photo current;

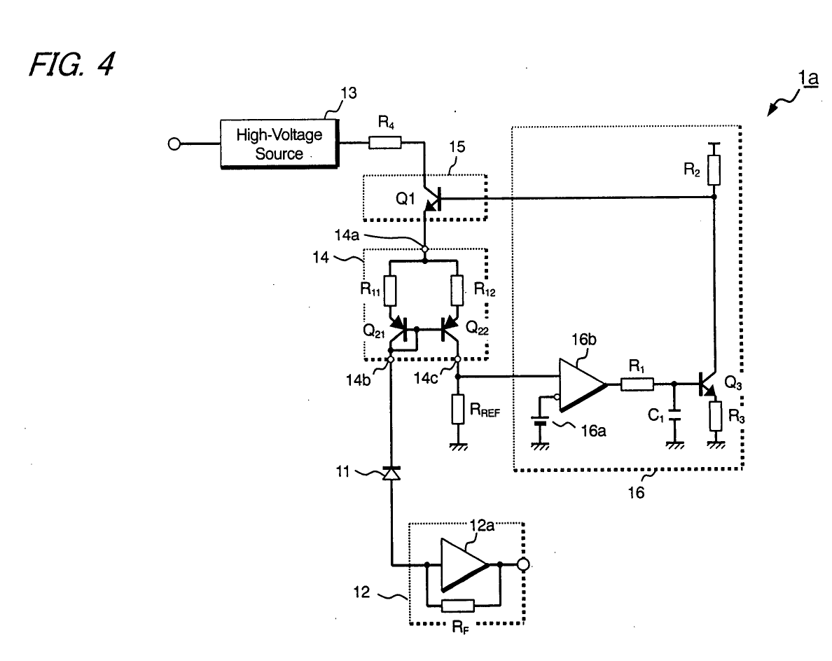

FIG. 4 is the light-receiving circuit according to the second embodiment of the present invention;

FIG. 5 shows a multiplication factor M of the avalanche photo diode against the bias voltage.

### DETAILED DESCRIPTION OF THE INVENTION

Next, preferred embodiments of the present invention will be described as referring to accompanying drawings.

### First Embodiment

FIG. 1 is an light-receiving circuit according to the first embodiment of the present invention.

The light-receiving circuit 1 comprises an avalanche photodiode (APD) 11, a high-voltage source 12, a pre-amplifier 13, a current-mirror circuit 14, a voltage control circuit 15, a feedback controlling circuit 16 and a sensing resistor R_{REF}.

The high-voltage source 12, the voltage control circuit 15, the current mirror circuit 14, the APD and the pre-amplifier 13 are serially connected in this order, namely, the cathode of the APD is connected to one of the current path of the current mirror circuit 14, and the anode of the APD is connected to the pre-amplifier 13.

The pre-amplifier 13 includes an inverting amplifier 13a and feedback impedance 13b connected between the input and the output of the inverting amplifier 13a.

The current mirror circuit 14 has one input port 14a and two output ports 14b and 14c. Between the input port 14a and one of the output ports 14b is provides a pnp-type transistor Q21 whose collector and the base are short circuited, while between the input port 14a and the other output port 14c is provided another pnp-type transistor Q22. Resistors R21 and R22 are connected between the input port 14a and the emitter of the transistor Q21 and that of the transistorQ22, respectively. In this current mirror circuit, when performance of transistors Q21 and Q22 are equivalent to each other, currents output from each output ports 14b and 14c are determined by a ration of each resistors R21 and R22. In the case that the resistance of resistors R21 and R22 are identical, the current output from the output port 14b is equal to the current from the output port 14c. Accordingly, a current signal I_{APD} that corresponds to the optical signal received by the APD 11 is equal to the current flowed from the output ports 14b of the current mirror circuit 14. At the same time, the current I_{REF} flowed from the other port 14c of the current mirror circuit 14 can be related to the signal current I_{APD}.

The voltage control circuit 15 includes an npn-type transistor Q1, where a voltage between the collector and the emitter thereof is controlled by a signal input to the base. Therefore, when a high-voltage V_{H} for the APD is applied to the collector of the transistor Q1, a voltage output from the emitter of the transistor Q1, which is practically applied to the APD, can be adjusted by the control signal applied to the base of the transistor Q1.

The feedback controlling circuit 16 includes a comparator 16a, a reference signal V_{REF}, three resistors R1 to R3, a capacitor C1 and a transistor Q3. The comparator 16a compares a voltage generated in the reference resistor R_{REF} by the current I_{REF} with the reference signal V_{REF}, and transmits the result of comparison to the transistor Q3. The resistor R1 and the capacitance, they are connected between the comparator 16a and the transistor Q3 and constitute a low-pass filter, set a large time constant for the closed loop formed by the voltage control circuit 15, the current mirror circuit 16 and the feedback controlling circuit, thereby stabilizing the closed loop and prohibiting the response of the closed loop to the optical signal input to the APD 11. In the case that the time constant of the closed loop is small such that the closed loop is capable of responding the optical signal, the current signal generated by the APD becomes small because the bias voltage supplied to the APD 11 generated by the closed loop may compensate the amplitude of the optical signal from moment to moment.

Next, operation of the receiving circuit will be described in detail.

Receiving the optical signal into the APD 11, the APD generates corresponding current signal I_{APD}. Due to the operation of the current mirror circuit 14 described above, a reference current I_{REF} equivalent to the signal current I_{APD} is output from the another output port 14c.

The comparator 16b of the feedback controlling circuit compares a voltage generated in the reference resistor R_{REF} due to the reference current I_{REF}, namely I_{REF}×R_{REF}, to the reference signal V_{REF}.

When the derived voltage, I_{REF}×R_{REF}, is smaller then the reference signal V_{REF}, namely, the signal current generated by the APD 11 is smaller than a defined value, the output of the comparator 16b is set to low level. Therefore, the transistor Q3 turns off, the collector of the transistor Q3 is nearly equal to the supply voltage Vcc, which appears in the output of the feedback controlling circuit 16c. Accordingly, the transistor Q1 that receives the output 16c of the feedback controlling circuit to the base thereof turns on and the high-voltage V_{H} is directly carried to the current mirror circuit 14 nearly as it is, thereby biasing the APD 11 with the high-voltage V_{H}.

In the case that the bias voltage of the APD 11 is high, the multiplication factor thereof also keeps high, and the large current is generated. Then, the reference current I_{REF} becomes large, the input of the comparator that is the voltage between the reference resistor R_{REF} increases and exceeds the reference signal V_{REF}, and the output of the comparator 16b turns to the high level. The transistor Q₃ that receives the output of the comparator 16v turns on, and the collector of which is lowered, whereby the voltage between the collector and the emitter of the transistor Q₁, the vase of which receives the collector level of the transistor Q₃, increases and the output of the voltage control circuit decreases.

The feedback loop thus described controls the reference current I_{REF}, which is equivalent to the signal current I_{APD}, equal to a current calculated by the reference signal V_{REF} divided by the reference resistor R_{REF}, V_{REF}/R_{REF}. One example of the feedback control is that the resistance of the reference resistor R_{REF}, the reference signal V_{REF}, resistors R₁₁ and R₁₂ are 1.5 kΩ, 1.5 V, 10 kΩ and 10 kΩ, respectively, and the transistors Q₁₁ and Q₁₂ have the same specification, then the feedback control starts at the signal current of 1 mA, and due to thus feedback control, the signal current I_{APD} does not exceed 1 mA.

FIG. 2 is an output current spectrum of the APD for the optical input. When 55 V is applied for the bias voltage V_{HV} and no optical input, because of no signal current is generated, the transistor Q₁ of the voltage control circuit completely tuns on. Therefore, the APD 11 is biased about 54 V, which is the high-voltage V_{H} reduced by the voltage drop (about 0.8 V to 1.0 V in the present case) at the transistor Q₂₁ of the current mirror circuit 14.

Increasing the optical input and reaching about −7 dBm, the APD generates about 1 mA as the signal current I_{APD} under the bias voltage of about 54 V and the feedback controlling starts its operation. At this bias condition, the multiplication factor of the APD may be estimated as about 5. Further increasing the optical input, the feedback control may operate so as to decrease the bias voltage to the APD, which is equivalent to reduce the multiplication factor thereof, and the bias voltage becomes about 30 V at the optical input of −3 dBm. Since the high-voltage V_{H} is 55 V, the difference of 25 V between the high-voltage and the practically applied bias voltage to the APD 11 is consumed by the transistor Q₁ of the voltage control circuit 16.

Still further increasing the optical input and amounting to 0 dBm, the feedback control sets the bias voltage to the APD equal to about 15V, and sets it about 11V at the optical input of +3 dBm. For such optical input, the average signal current of 1 mA for the APD 11 may be maintained.

### Second Embodiment

In the first embodiment described above, the feedback control operates so as to maintain the average signal current to be 1 mA. As shown in FIG. 2, the condition that the signal current is 1 mA is sensitive to change of the bias voltage, namely, a ∂(I_{APD})/∂(V_{APD}) in FIG. 2 is large at the point where the signal current is 1 mA. The circuit is susceptible to a noise included in the applied bias V_{APD}.

A circuit that escapes from the noise is shown in FIG. 3, in which a resistor R₄ is inserted between the high-voltage source 12 and the voltage control circuit 15. By inserting the resistor R₄, the fluctuation of the high-voltage [symbol] V_{H} is equivalently reduced to a ratio of the internal resistance of the APD 11 to the resistance of the resistor R₄. That is, denoting the internal resistance of the APD 11 as R_{APD}, the fluctuation [symbol] V_{APD} of the bias voltage to the APD 11 is: [symbol]
V_{APD}=V_{HV}•R_{APD}/(R_{APD}+R₄).

The case that the resistance of the resistor R₄ is 10 kΩ will be described below.

When no optical signal is input, the output of the feedback control circuit 16 is set to the high level because of no signal current generated by the APD 11. The transistor Q₁ of the voltage control circuit turns on and the high-voltage VH from the high-voltage source is applied to the APD 11. Therefore, the APD is biased at 55 V. Increasing the optical input, the APD 11 generates a signal current I_{APD} and twice of the signal current will flow through the resistor R₄ due to the operation of the current mirror circuit.

Reaching the signal current I_{PAD} of the APD 11 to be 1 mA, the feedback control becomes active. In this occasion, the voltage drop at the resistor R₄ becomes 20 V because twice of the signal current I_{APD} is flowing therethrough, whereby the APD 11 is applied by 35 V as the bias voltage. Referring to FIG. 2, when the APD generates the signal current of 1 mA under the bias voltage of 35 V, the optical input is about −4 dBm. By inserting the resistor R₄ between the high-voltage source 12 and the voltage control circuit 15, a starting condition of the feedback control shifts from −7 dBm to −4 dBm.

In the case that the feedback control starts at the bias voltage of 55 V, which is same as that of the first embodiment, the high voltage source V_{H} may be raised to 75 V. It is applicable to connect a Zener diode in parallel to the resistor R₄, when the resistor R₄ with greater resistance is used to cramp the resistor R₄. Alternatively, the resistor R4 may be inserted between the current mirror circuit 14 and the APD 12.

Although preferred embodiments thus described are directed to the avalanche photodiode (APD), the present invention will be also applicable not only to a PIN-photodiode but also a photodiode having a general configuration. Such variations are not to be regarded as a departure from the spirit and scope of the invention, and all such modifications as would be obvious to one skilled in the art are intended for inclusion within the scope of the following claims.

1. An light-receiving circuit for receiving an optical signal with a predetermined transmission speed, comprising:
a light-receiving device;
a bias supply for providing a bias voltage to said light-receiving device;
a reference resistor for detecting a signal current generated by said light-receiving device; and
a feedback control circuit for receiving said signal current detected by said reference resistor and feedback controlling said bias supply such that said signal current is maintained to be a predetermined magnitude.

2. The light-receiving circuit according to claim 1, wherein said bias supply includes a high voltage source and a voltage control circuit serially connected to said high voltage source, said feed back control circuit feedback controlling said voltage control circuit.

3. The light-receiving circuit according to claim 1, further comprises a current mirror circuit having one input port connected to an output of said bias supply and two output ports, one of two output ports being connected to said light-receiving device and the other of two output ports being connected to said reference resistor.

4. The light-receiving circuit according to claim 1, wherein said feedback control circuit has a time constant greater than said predetermined transmission speed.

5. The light-receiving circuit according to claim 1, wherein said light-receiving device is an avalanche photodiode having an anode electrode and a cathode electrode connected to said bias supply.

6. The light-receiving circuit according to claim 1, wherein said light-receiving device is a PIN photodiode having an anode electrode and a cathode electrode connected to said bias supply.

7. The light-receiving circuit according to claim 1, further comprises a pre-amplifier connected to said light-receiving device.

8. An light-receiving circuit for receiving an optical signal having a predetermined transmission speed, said light-receiving circuit comprising:
a high voltage source;
a voltage control circuit connected to said high voltage source and outputting a controlled bias voltage;
a current mirror circuit connected to said voltage control circuit, said current mirror circuit receiving and outputting said controlled bias voltage;
a photodiode connected to said current mirror circuit for receiving said optical signal and generates a signal current corresponding said optical signal by providing said controlled bias voltage;
a reference resistor for detecting said signal current; and
a feedback control circuit connected between said reference resistor and said voltage control circuit, said feedback control circuit feedback controlling said voltage control circuit such that said signal current detected through said reference resistor is maintained to be a predetermined magnitude,
wherein said photodiode is an avalanche photodiode.
